(19) United States
(12) Patent Application Publication
(10) Pub. No.: US 2025/0050455 A1
(43) Pub. Date: Feb. 13, 2025

(54) DEVICE FOR THE THERMAL PROCESSING OF A WORKPIECE BY LASER RADIATION, AND PROTECTIVE HOOD SUITABLE THEREFOR

(71) Applicant: Messer Cutting Systems GmbH, Gross-Umstadt (DE)

(72) Inventors: Thomas DÜNZKOFER, Gross-Umstadt (DE); Ingo GÖLLER, Gross-Umstadt (DE); Matthias BREITWIESER, Gross-Umstadt (DE)

(21) Appl. No.: 18/720,776

(22) PCT Filed: Dec. 14, 2022
(86) PCT No.: PCT/EP2022/085834

§ 371 Date: Jun. 17, 2024

(30) Foreign Application Priority Data
Dec. 20, 2021 (DE) 10 2021 133 851.4

(51) Int. Cl. B23K 26/70

(52) U.S. Cl. CPC B23K 26/706

(57) ABSTRACT

A device for the thermal processing of a workpiece with a fiber laser, which generates laser radiation with a wavelength in a range, in particular, from 1020 nm to 1120 nm. The device includes a laser processing machine, having a support surface for the workpiece, a laser processing unit with a laser machining head, and a movement unit with a transverse gantry for moving the laser processing head relative to the support surface. A laser protective hood surrounds the laser processing head, is open towards the support surface, and is movable by the movement unit together with the laser processing head. The protective hood has an outer wall and an inner wall, and a cavity therebetween. At least one laser-light sensor is arranged in the cavity. A laser protection housing surrounds the laser processing machine and the protective hood in a hood-like manner.

### TECHNICAL BACKGROUND

The present invention relates to a device for the thermal processing of a workpiece using laser radiation, comprising a fiber laser which generates laser radiation, in particular with a wavelength in the range from 1,020 nm to 1,120 nm, and a laser processing machine, comprising:
a support surface for the workpiece,
a laser processing unit with a laser processing head, and
a movement unit with a transverse gantry for moving the laser processing head relative to the support surface, wherein the transverse gantry comprises a support beam extending above the support surface, which is supported at the side of the support surface and can be moved on tracks.

Furthermore, the present invention relates to a laser protective hood for a laser processing head of a laser processing machine with a fiber laser which generates laser radiation in particular with a wavelength in a range from 1,020 nm to 1,120 nm.

The device according to the invention is configured for the thermal processing of a workpiece by means of laser radiation. The term “thermal processing” includes welding, cutting or marking the workpiece. According to the invention, a fiber laser is used for thermal processing of the workpiece, which generates laser radiation in particular with a wavelength in a range from 1,020 nm to 1,120 nm.

A “laser processing machine” within the meaning of the invention comprises a workpiece support surface, a laser processing unit and a movement unit in the form of a transverse gantry arranged transversely to the longitudinal axis of the work table, on which a laser processing head is arranged. The “laser processing head” is a movably mounted machine component for emitting laser radiation in the direction of the support surface. The laser processing head regularly comprises the focusing optics of the laser processing unit. The movement unit is configured so that it can be used to move the laser processing head in space, preferably in all three spatial directions.

In fiber lasers, the laser radiation is formed by laser-active dopants in the core of a glass fiber. The laser-active core is surrounded by a cladding with a lower refractive index. Fiber lasers are characterized, inter alia, by efficient excitation of the laser-active medium (by laser diodes) and comparatively simple beam guidance in optical waveguides as well as high beam quality. Fiber lasers suitable for thermal material processing include ytterbium lasers, for example.

### PRIOR ART

Known devices that are used for the thermal processing of metallic workpieces are often surrounded by protective elements that are intended to protect people as well as sensitive objects in the vicinity of the device from unintentional exposure to the laser radiation. A simple example of such a protective element is an enclosure surrounding the device.

When using a fiber laser with a wavelength in the range of 1,020 nm to 1,120 nm, special requirements must be placed on the protective elements. In contrast to CO₂ lasers, these lasers pose a danger not only from the direct or reflected laser beam, but also from the diffuse scattered light. This is because the wavelength of the fiber laser is close to the visible range. As a result, the laser radiation is not absorbed in the lens of the eye, as is the case with CO₂ lasers, but can hit the retina. Even the smallest leaks in a protective element can be dangerous. Effective protection can be achieved with a full enclosure. This regularly comprises several interconnected, modular protective elements.

In the simplest case, the protective elements are configured so that they can withstand exposure to the laser beam for a specified period of time. Such protective elements are also referred to as passive protective elements. Enclosures made of passive protective elements usually consist of more or less thick metal plates. When using fiber lasers, the passive protective elements must have a comparatively large wall thickness. The disadvantage of passive protective elements is that they require a high material input. A complete enclosure is therefore very heavy, requires a lot of space and is correspondingly expensive.

For the above-mentioned reasons, active protective elements with a sensor element are often used instead of passive protective elements for enclosure, which can be used to detect imminent or actual damage to a protective element. The detection of damage usually leads to an automatic shutdown of the laser processing unit. Active protective elements can be made from thinner metal plates. Although they are less resistant than passive protective elements, they are easier and cheaper to manufacture. Active protective elements often have a double-walled design, whereby the sensor element is a laser light sensor located in the cavity of the double wall, which is configured to detect laser radiation that strikes it.

However, conventional laser light sensors only have a limited detection range in which imminent damage can be reliably detected. For larger enclosures in particular, it is usually necessary to use a large number of laser light sensors. In principle, however, it is desirable to keep the number of laser light sensors and the sensor technology as a whole as low as possible, both in terms of costs and the complexity of the technology.

DE 10 2014 116 746 B4 therefore proposes a modular active laser protection wall in which a radiation sensor is not provided in each wall element. Instead, the side surfaces of the wall modules are configured to be as open as possible so that the laser radiation entering a wall module without a radiation sensor can be deflected into a wall module in which a radiation sensor is arranged.

However, due to the limited detection range of known laser light sensors, a large number of laser light sensors are still required for larger protective enclosures. This applies in particular to protective enclosures whose protective walls are longer, wider and/or higher than 5 m. But even with laser safety barriers arranged at an angle to each other, at least one separate laser light sensor must usually be provided for each of these laser safety barriers, and even several laser light sensors in the case of longer laser safety barriers.

A two-dimensional fiber laser cutting system is known from DE 20 2018 105 888 U1. The cutting system comprises a machine table and a longitudinally displaceable gantry with a cutting head. The cutting system is provided with an enclosure on all sides, which encloses the working area of the cutting system like a hood.

EP 3 308 898 A1 discloses a protective housing for a machine for processing a workpiece with a laser beam from a fiber laser. The protective housing is attached to one end of a robot arm; it has a double-walled design. The spaced-apart walls of the protective housing enclose a cavity in which a sensor for electromagnetic radiation can be arranged.

DE 10 2012 216 632 A1 discloses a laser cutting machine with a protective element that shields the laser processing head and is configured as a cavity in which a sensor for detecting laser radiation is arranged. The sensor is connected to a control device that can switch off the laser.

DE 20 2007 012 255 U1 discloses an enclosure for a laser cutting machine which has a partial volume bounded by walls spaced at a distance of approximately 35 mm from one another. A unit for detecting the laser radiation passing through the enclosure is composed of several receivers and several transmitters arranged on a circle concentrically surrounding the receivers.

DE 10 2017 002 649 B4 relates to a laser cutting machine with a laser protective housing and sealing brushes mounted on it, which enclose the contour of the housing in the direction of the surface. The sealing brushes are made of graphite and/or fiber-metal composite and are under high electrical voltage. A safety sensor system adapted to the electrical conductivity of the bristles of the sealing brushes is used to switch off the laser. A laser cutting machine with a protective hood comprising a brush arrangement is also described in EP 3 402 625 B1.

DE 102019207940 A1 describes an unbalance measuring device for a rotating body, whereby the unbalance forces occurring are detected by means of force sensors and the unbalance of the rotating body and the necessary unbalance correction are calculated from this. In order to realize the unbalance correction, a laser beam is shone onto the rotating body. The laser is configured, for example, as a continuously operating fiber laser with a laser power of, for example, 12 kW (kilowatts), whereby the wavelength is adapted in particular to the material of the rotating body to be removed. For example, a fiber laser with a wavelength of around 1060 nm is used for carbon steel.

WO 2020/117816 A1 discloses a high-power all-fiber laser system with several spaced-apart fiber lasers that are combined via a tapered fiber combiner. This contains a central guide fiber and a plurality of peripheral guide fibers. Depending on the type and number of fiber lasers connected, different laser powers and laser beam shapes can be achieved.

DE 100 59 246 A1 describes a protective device for a hand-held laser device, in particular for laser marking. A sealing element can be coupled to the hand-held laser device, which has a tubular or conical area that surrounds the laser beam during operation.

### Technical Object

The object underlying the present invention is that of providing a device for the thermal processing of a workpiece with a fiber laser, which is reliable, easy to operate and particularly cost-effective.

Furthermore, the present invention is based on the object of providing a laser protection element for such a device which is safe to operate, easy to operate and particularly cost-effective.

### SUMMARY OF THE INVENTION

With regard to the device, the above-mentioned object is achieved, according to the invention, by a device for the thermal processing of a workpiece using laser radiation, comprising a fiber laser which generates laser radiation in particular with a wavelength in the range from 1,020 nm to 1,120 nm,
a) having a laser processing machine, comprising:
   a support surface for the workpiece,
   a laser processing unit with a laser processing head,
   a movement unit with a transverse gantry for moving the laser processing head relative to the support surface, the transverse gantry having a support beam extending above the support surface, which is supported at the side of the support surface and can be moved on tracks,
b) and a laser protective hood which surrounds the laser processing head, is open towards the support surface and can be moved by the movement unit together with the laser processing head, and which has an outer wall and an inner wall, wherein a cavity exists between the outer wall and the inner wall in which at least one laser light sensor is arranged,
c) and with a laser protective housing that encloses the support surface, the laser processing unit, the movement unit and the laser protective hood like a hood.

If a laser processing machine with a fiber laser is used for workpiece processing, an external protective housing is required. Such a protective housing is comparatively expensive, especially for workpieces longer than 5 m, as several laser light sensors are required and signal detection is correspondingly complex.

The present invention is based on the idea of additionally providing the laser processing head with a separate, inner laser protective hood which, on the one hand, completely prevents the emission of directed laser radiation and largely prevents the emission of diffuse laser radiation and, on the other hand, withstands even the foreseeable maximum radiation. This requires a corresponding design of the inner laser protective hood, both with regard to the resistance of the laser protective hood to laser radiation and with regard to its impermeability to optical radiation. Known laser protective hoods, such as those used for devices with a CO₂ laser source, are not suitable as protective hoods for fiber lasers because they are not double-walled and do not offer active protection against high laser power. In addition, the area between the protective hood and the workpiece or between the protective hood and the support surface proves to be problematic with these protective hoods, as this is not sealed as well as possible with regard to back reflections.

Because the laser protective hood according to the invention is configured as a double-walled active protective hood with at least two laser light sensors, the laser protective hood has a lower weight compared to a passive protective hood while providing the same level of protection. This has several advantages: On the one hand, the laser protective hood is easier to move relative to the support surface, and the movement unit also has to meet lower requirements. On the other hand, a more precise movement of the laser processing head is also possible, as this is also moved when the laser protective hood is moved.

According to the invention, at least one laser light sensor is arranged in the cavity of the laser protective hood. With a single laser light sensor, the cavity can be completely monitored laterally and upwards for laser light ingress if the geometry and size of the laser protective hood are suitable. Depending on the size and geometry of the cavity, however, the use of several laser light sensors is also advantageous.

In this case, however, it has proven to be advantageous if the cavity comprises several subspaces, with at least one laser light sensor being arranged in each subspace. Advantageously, the subspaces are adjacent and adjoin one another. By providing subspaces, it can be ensured that even with larger laser protective hoods, but also with laser protective hoods with a complex geometric shape, sufficient safety is guaranteed with regard to the detection of a laser beam entering the subspace. In addition, damage to the laser protective hood can also be easily localized by assigning the laser light sensors to subspaces.

Due to its hood shape, the laser protective hood cannot be completely sealed against diffuse laser radiation except towards the workpiece surface or contact surface. Therefore, the laser protective hood cannot completely replace an external protective housing. However, the emission of diffuse laser radiation can be reduced if the dimensions of the laser protective hood are chosen to be larger. In addition, the laser protective hood means that the laser resistance of the outer protective housing must meet lower requirements. This provides the advantage that instead of a large active outer protective housing with several laser light sensors, a cost-effective, single-walled laser protective housing with a low wall thickness can be used. For example, a laser protective housing made of sheet steel with a wall thickness of 1.5 mm to 2.5 mm is usually sufficient. Such a laser protective housing is less material-intensive and therefore considerably more cost-effective. In addition, there is no need for complex control and checking of the sensors in the outer protective housing.

The laser protective housing encloses the support surface, the laser processing unit, the movement unit and the laser protective hood like a hood, i.e. laterally and upwards. The protective housing is open at the bottom, i.e. on the floor side, but is sealed off from the floor in such a way that neither directed radiation nor diffuse scattered radiation can escape from the laser protective housing.

In a preferred embodiment of the device according to the invention, the laser processing machine comprises a first support surface for a first workpiece and a second support surface for a second workpiece, and the laser protective housing can be moved in such a way that it encloses either the first support surface or the second support surface.

In order to be able to thermally process a workpiece in a device according to the invention, the workpiece must be moved onto the support surface before thermal processing, and it must be removed from the support surface again after thermal processing. This manipulation can be carried out using a crane or other lifting device, for example. In a device with a protective housing, however, positioning the workpiece on the support surface and removing it is difficult because there is only limited space available for this, even with a partially opened laser protective housing. Loading and unloading the workpiece is made easier if the device comprises two support surfaces and the laser protective housing can be moved between a first position surrounding the first support surface and a second position surrounding the second support surface. This provides the advantage that one of the support surfaces is located inside the laser protective housing, while the other is located outside the laser protective housing. The support surface located outside the laser protective housing can be loaded quickly and easily, prepared for subsequent processing and then unloaded again, while at the same time a workpiece located on the other support surface can be thermally processed. This allows downtimes to be reduced and process times to be shortened.

Furthermore, the lower the mass of a laser protective housing, the easier it is to move it between a first and a second position. By providing an inner laser protective hood, the outer laser protective housing can be single-walled and configured without laser light sensors. This not only makes the laser protective hood lighter, but it is also not necessary to ensure that the electrical contacting of the laser light sensors is not impaired by the movement of the laser protective housing. Both of these features make it much easier to move the laser protective housing.

It has proven to be advantageous if the laser protective hood has an upper hood area that is dome-shaped, conical or truncated pyramid-shaped, and if the at least two laser light sensors are arranged in the upper hood area.

A laser light sensor can also detect angled, neighboring subspaces of a cavity up to an angle of 45°, provided they are connected to each other. The laser protective hood encloses the laser processing head at the sides and at the top. An angular laser protective hood whose walls are angled by more than 45° usually requires the use of a laser light sensor in each wall of the laser protective hood or a suitable reflector, such as a mirror. This applies in particular to the upper hood area. A dome-shaped, conical or truncated pyramid-shaped upper hood area helps to avoid angles of more than 45°. Such a shape of the upper hood area allows the number of laser light sensors to be kept as low as possible. This is not only cost-effective, but also reduces the effort required for electrical contacting of the sensors and thus the weight of the laser protective hood, which makes it easier to move. Ideally, a single laser light sensor arranged in the center of the entire upper hood area is sufficient. Preferably, the number of laser light sensors of the laser protective hood is less than ten, particularly preferably less than six.

It has proven to be advantageous if at least two laser light sensors, preferably at least three laser light sensors, particularly preferably at least four laser light sensors, are arranged in the cavity.

Depending on the size and exact geometry of the cavity, one laser light sensor may not be sufficient to reliably detect laser radiation entering the cavity. Advantageously, the cavity therefore comprises at least two, preferably at least three, particularly preferably at least four, laser light sensors. Advantageously, the cavity has a number of subspaces corresponding to the number of laser light sensors, wherein one of the laser light sensors is arranged in each subspace. It has proven to be advantageous if at least one laser light sensor is arranged in the upper hood area. Preferably, at least two laser light sensors are arranged in the upper hood area. Advantageously, the remaining laser light sensors are arranged outside the upper hood area. The upper hood area represents the hood cover. In the upper hood area, the detection of laser radiation entering it is made more difficult by the fact that the cavity is regularly angled. If a laser light sensor is provided in the upper hood area, it has proven to be useful if it is arranged in a central position in relation to the upper hood area, for example in the middle of the dome in the case of a dome-shaped upper hood area. If two or more laser light sensors are arranged in the upper dome area, it has proven useful if these are arranged symmetrically to the central longitudinal axis of the laser protection dome.

In a preferred modification of the device according to the invention, it is provided that the laser processing head has a working axis and can be pivoted relative to the laser protective hood in such a way that, when pivoted both in the x-direction and in the y-direction, the working axis encloses a pivoting angle α of up to 50° with a surface normal of the support surface, wherein the laser protective hood is dimensioned in such a way that a laser beam reflected by an ideally flat workpiece strikes the inner wall of the laser protective hood irrespective of the pivoting angle α.

The laser protective hood can surround both a vertical laser processing head and a laser processing head for bevel cutting.

A vertical laser processing head is aligned perpendicular to the support surface during the cutting process; it is moved by the movement unit in the x, y and z directions. Compared to a laser processing head for bevel cutting, a vertical laser processing head generally poses less of a risk, as a reflected laser beam is generally reflected vertically and is shadowed by the laser processing head itself, i.e. it does not usually hit a wall of the laser protective hood. However, even when using a vertical laser processing head, it is possible that a beam incident perpendicular to the support surface or the workpiece can be reflected outwards at an angle past the laser processing head, for example by a workpiece tilted relative to the support surface.

In addition to movement in the x, y and z directions, a laser processing head for bevel cutting can be pivoted by the movement unit in two further axes. These are often referred to as the a and b axes. The ability to pivot the laser processing head relative to the support surface enables a bevel to be cut into the workpiece. The ability to pivot the laser processing head in both the x- (a-) and y- (b-) directions enables bevel cutting even with curved cutting shapes. With a pivot angle α of up to 50°, bevel angles in the range from 0° to 50° can be produced. Advantageously, the pivot angle α is infinitely adjustable. When using a laser processing head for bevel cutting, the laser beam often hits the workpiece surface at a flat angle (0° to 50° to the vertical). It is therefore much more likely that a reflected beam will hit a wall of the laser protective hood. Consequently, such a laser processing head is also associated with a greater risk potential. The maximum adjustable pivot angle α affects the size of the laser protective hood. Under the condition that a laser beam reflected from an ideally flat workpiece should hit the inner wall of the laser protective hood regardless of the pivot angle α, the laser protective hood must also be larger with a given distance between the workpiece and the laser protective hood as the permissible pivot angle α increases. A maximum pivot angle α of 50° is sufficient for most thermal processing methods.

Advantageously, the cavity between the outer wall and the inner wall has a cavity width in the range of 35 mm to 50 mm, preferably in the range of 40 mm to 50 mm.

A cavity width in the above-mentioned range has a technical advantage because the cavity width has an influence on the tightness of the laser protective hood for diffuse scattered radiation. This is because the greater the cavity width, the wider the free space covered by the laser protective hood in relation to the workpiece or the support surface. In order for scattered radiation to penetrate to the outside, it must pass through this free space without hitting the laser protective hood or the workpiece or the support surface. A cavity with a width of less than 35 mm only retains diffuse scattered light to a limited extent. In addition, a cavity with such a small cavity width is only partially suitable for accommodating a laser light sensor. A cavity width of more than 50 mm is associated with a comparatively large-volume laser protective hood. Reliable detection of laser radiation requires the largest possible sensor element for a wide cavity. In order to be able to process the entire contact surface, a certain amount of space must remain around the contact surface on all sides. The wider the cavity, the larger this space becomes. A cavity width of more than 50 mm is only associated with a slight improvement in tightness for scattered radiation. A cavity width of 40 mm to 50 mm has proved particularly effective.

It has proven successful if the laser protective hood covers an area of 0.5 m² to 1.0 m² on the contact surface.

The laser protective hood according to the invention differs from known laser protective hoods in its size. In principle, the larger the area covered by the laser protective hood on the support surface, the better it protects against the emission of diffuse scattered radiation. However, the larger the laser protective hood, the greater its mass, the more inert it is and the more difficult it is to position precisely together with the laser processing head. This proves to be problematic, as the most precise positioning and guidance of the laser beam is particularly important for thermal processing devices. The above-mentioned surface area provides the following technical advantage: If the laser protective hood covers an area of less than 0.5 m² on the support surface, the effect of the laser protective hood according to the invention, which prevents the emission of diffuse scattered radiation, is lost. If the laser protective hood covers an area of more than 1.0 m² on the support surface, this makes it more difficult to position the laser protective hood and laser processing head precisely.

In an advantageous embodiment of the device according to the invention, it is provided that the laser protective hood comprises a lower edge which extends at a distance from the support surface while leaving a free space, wherein a laser protective curtain with flexible cladding parts is attached to the laser protective hood, which parts project into the free space between the laser protective hood and the support surface and are configured in such a way that damage to one of the cladding parts by a laser beam causes the laser processing unit to be switched off.

To avoid a collision between the laser protective hood and the workpiece, it is unavoidable that a free space remains between the lower edge of the laser protective hood and the contact surface. However, this free space is a weak point of the laser protective hood, as diffuse scattered radiation can escape from it. This applies in particular to laser radiation that can pass through the free space at a small angle to the support surface or workpiece surface. However, the proportion of scattered radiation escaping from the free space can be reduced by using a laser protective curtain whose flexible cladding parts protrude into the free space. Naturally, such a laser protective curtain is only a short distance from the laser beam and therefore from the thermal processing process. Consequently, the laser protective curtain can also be easily damaged. To ensure that the laser protective curtain is always in a proper condition, the protective curtain is configured in such a way that damage to the protective curtain can be detected, for example by interrupting an electrical circuit. The detection of damage results in the laser processing unit being switched off.

Advantageously, the movement unit has a horizontal travel path that is limited so that a minimum distance of 1,440 mm remains between the laser protective hood and the laser protective housing, and a vertical travel path that is configured so that a minimum distance of 90 mm, preferably at least 100 mm, remains between the laser protective hood and the support surface.

The laser processing head can be moved relative to the support surface using the movement unit. It must be possible to move the laser processing head with the movement unit over the entire support surface and position it above the entire support surface. If the laser processing head is positioned at the edge of the support surface, the laser protective hood protrudes beyond the support surface. To prevent a collision between the laser protective hood and the laser protective housing, a minimum distance must exist between the laser protective housing and the laser protective hood. In addition, a minimum distance must also be maintained between the laser protective hood and the support surface in order to prevent collisions. In this context, it has proven useful if the laser processing head with the movement unit can be moved perpendicular to the support surface. This makes it easy to adjust the distance between the laser protective hood and the support surface to different workpiece thicknesses. Furthermore, the movability of the laser processing head perpendicular to the support surface can be used to prevent a collision of the laser processing head with a raised part of the workpiece.

With regard to the laser protection element, the above-mentioned object is achieved according to the invention by a laser protective hood which has an outer wall and an inner wall, wherein a cavity exists between the outer wall and the inner wall in which at least one laser light sensor is arranged.

The laser protective hood according to the invention is configured to withstand the foreseeable maximum irradiation and to completely prevent the emission of directed laser radiation and to largely prevent the emission of diffuse laser radiation. This requires a corresponding design of the inner laser protective hood, both with regard to the resistance of the laser protective hood to laser radiation and with regard to its impermeability to optical radiation.

The laser protective hood according to the invention is configured as a double-walled active protective hood with at least one laser light sensor and has a lower weight with the same level of protection compared to a passive protective hood. This provides several advantages: On the one hand, the laser protective hood is easier to move relative to the support surface and the movement unit also has to meet lower requirements. On the other hand, a more precise movement of the laser processing head and laser protective hood is also possible.

According to the invention, at least one laser light sensor is arranged in the cavity of the laser protective hood. With a single laser light sensor and a suitable size and geometry of the laser protective hood, the cavity can be completely monitored laterally and upwards for laser light ingress. Due to its hood shape, the laser protective hood cannot be completely sealed off from diffuse laser radiation except towards the workpiece surface or support surface. The emission of diffuse laser radiation cannot be avoided, as back reflections can always occur, for example from the support surface. The workpiece support consists, for example, of narrow (3 mm to 10 mm) support bars made of steel arranged on edge with a serrated or wavy upper surface. The horizontal distance between the parallel bars is typically 40 mm to 60 mm. The workpieces only have punctiform contact points to the bars so that the slag expelled from the cutting gap can exit downwards into the cutting table as unhindered as possible. The laser radiation emerging through the cutting gap hits the underside of the table and can be diffusely reflected from there.

Therefore, the laser protective hood cannot completely replace an external protective housing. However, the emission of diffuse laser radiation can be reduced if the dimensions of the laser protective hood are chosen to be larger. Due to the laser protective hood according to the invention, lower requirements are placed on an external protective housing with regard to laser resistance.

In a preferred modification of the laser protective hood according to the invention, it is provided that it has an upper hood region which is dome-shaped, conical or truncated pyramid-shaped, and that the at least two laser light sensors are arranged in the upper hood region.

A dome-shaped, conical or truncated pyramid-shaped upper hood area helps to avoid angles of more than 45° as far as possible. Such a shape of the upper hood area allows the number of laser light sensors to be kept as low as possible. This is not only cost-effective, but also reduces the weight of the laser protective hood, which makes it easier to move. Ideally, a single laser light sensor arranged in the center of the entire upper hood area is sufficient. Preferably, the number of laser light sensors of the laser protective hood is less than ten, particularly preferably less than six.

Advantageously, at least two laser light sensors, preferably at least three laser light sensors, particularly preferably at least four laser light sensors, are arranged in the cavity.

Depending on the size and exact geometry of the cavity, a single laser light sensor may not be sufficient to reliably detect laser radiation entering the cavity. Advantageously, the cavity therefore comprises at least two, preferably at least three, particularly preferably at least four, laser light sensors. Particularly in the upper hood area, the detection of laser radiation entering the cavity is made more difficult by the fact that the cavity is regularly angled.

### EXEMPLARY EMBODIMENT

In the following, the device according to the invention for the thermal processing of a workpiece and the protective hood according to the invention are explained in more detail with reference to the drawings. The figures show schematically:

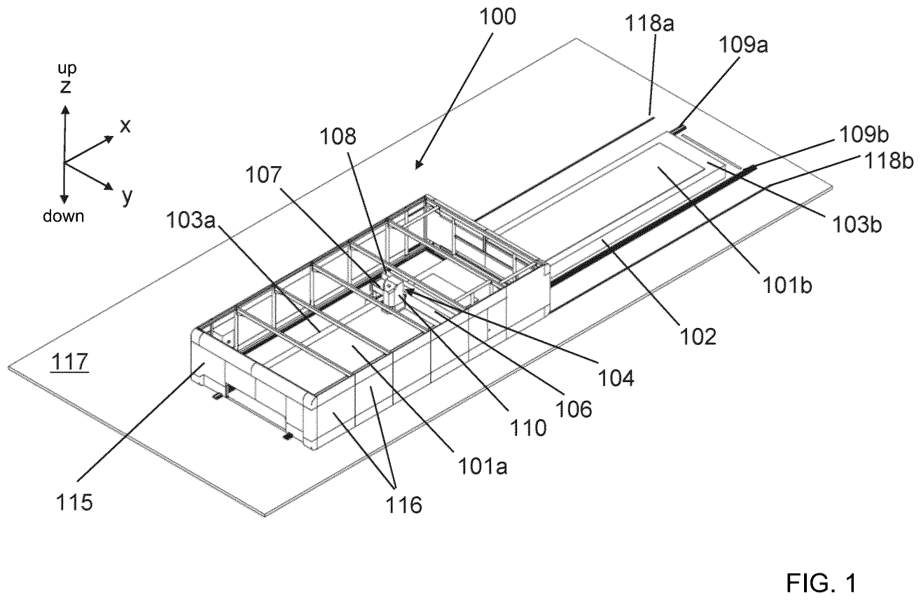

FIG. 1 a device according to the invention for the thermal processing of a workpiece with a laser protective hood and a laser protective housing,

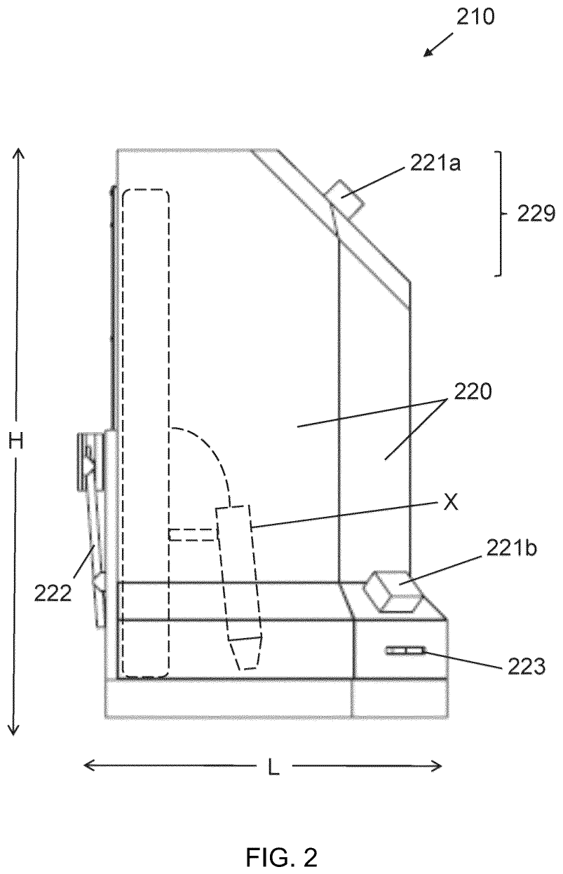

FIG. 2 a side view of a laser protective hood according to the invention,

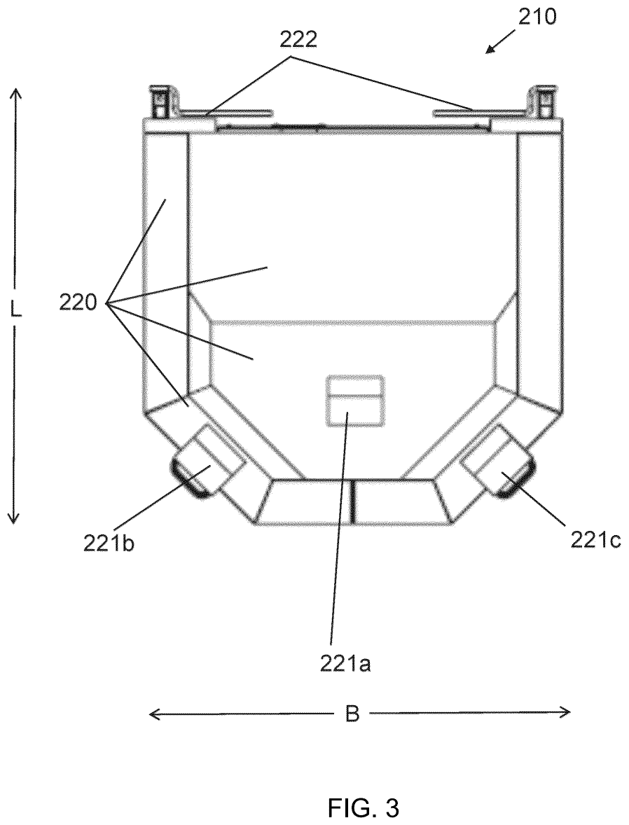

FIG. 3 a top view of the laser protective hood according to the invention shown in FIG. 2,

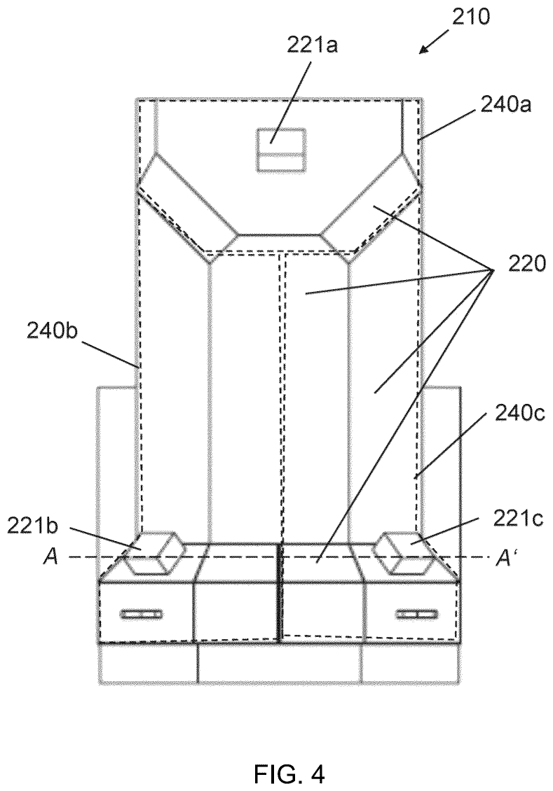

FIG. 4 an unfolded view of the laser protective hood according to the invention shown in FIG. 2,

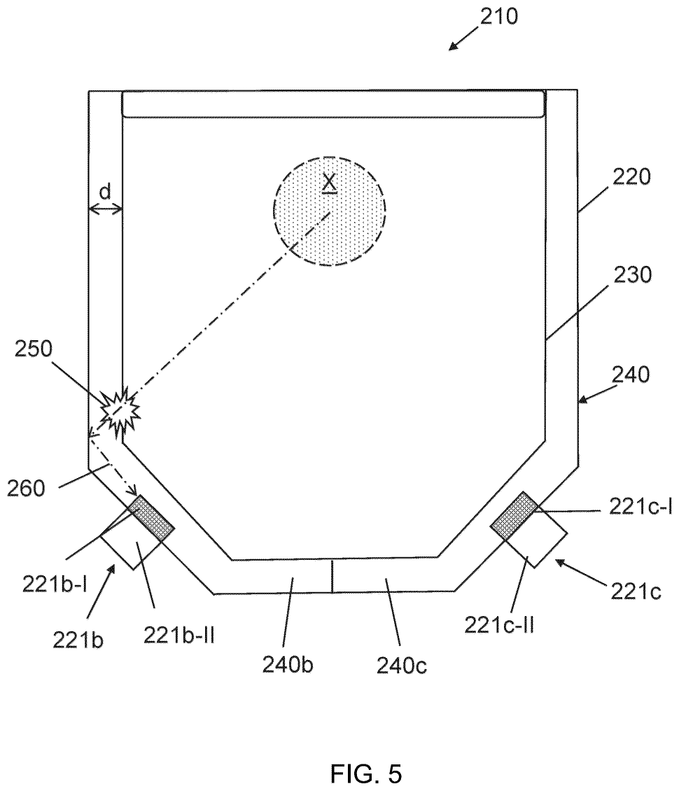

FIG. 5 the laser protective hood according to the invention from FIG. 2 in section A-A′,

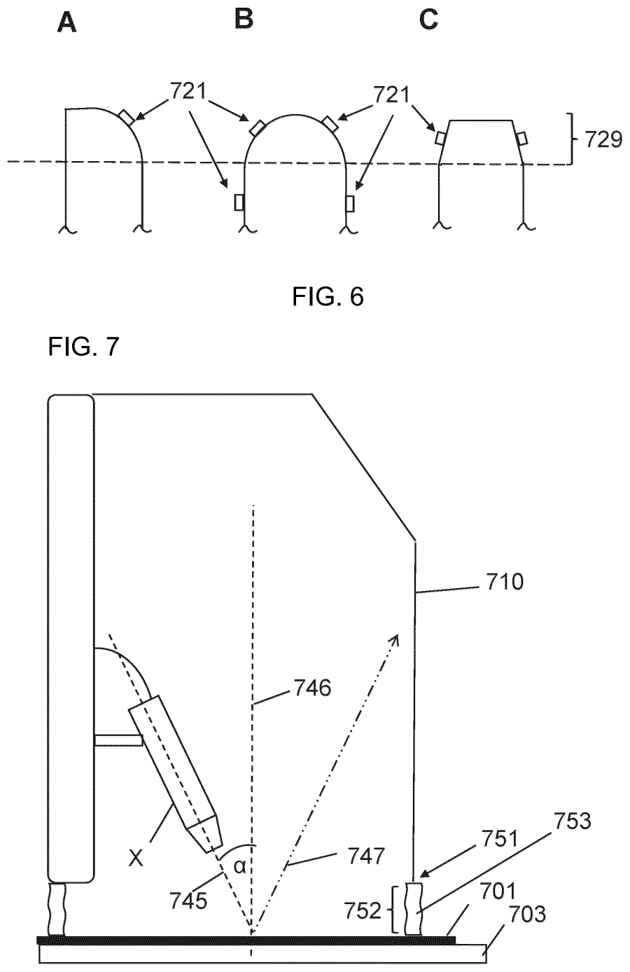

FIG. 6 laser protective hoods (A, B, C) according to the invention with different hood geometries,

FIG. 7 a laser protective hood according to the invention with a laser protective curtain, and

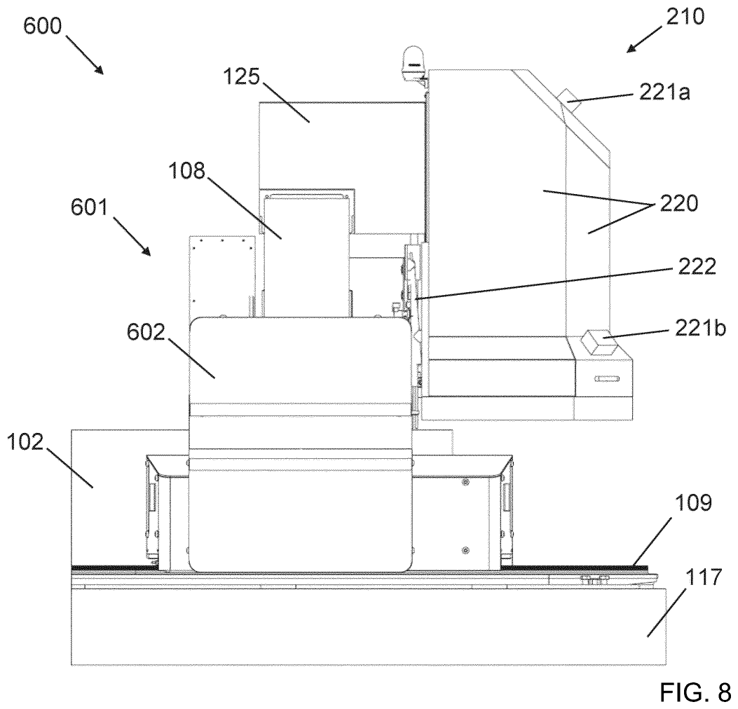

FIG. 8 the laser protective hood according to the invention from FIG. 2 on a movement unit with a transverse gantry.

FIG. 1 shows a device 100 configured for the thermal processing of metal or metallic workpieces using laser radiation. The device 100 is mounted on a base 117 and connected to it. For the purpose of illustrating the device 100 and its mode of operation, FIG. 1 also shows two identical workpieces 101a, 101b made of steel, which are not themselves part of the device 100. The workpieces 101a, 101b each have a length of 12 m, a width of 3 m and a thickness of 25 mm.

The device 100 comprises a laser processing machine, a laser protective hood 110 and a laser protective enclosure 115. In detail:

The laser processing machine comprises a work table 102, a laser processing unit 104 and a movement unit 106.

The work table 102 is made of steel and has a length of 28 m, a width of 3,850 mm and a height of 720 mm. It is provided with two support surfaces 103a, 103b, on each of which one or more workpieces can be placed. Both support surfaces 103a, 103b have a length of 13,800 mm and a width of 3,250 mm. In FIG. 1, the workpiece 101a rests on the support surface 103a and the workpiece 101b rests on the support surface 103b.

In the present case, the laser processing unit comprises a fiber laser and a laser processing head. Both are not shown in FIG. 1. The fiber laser has a laser output power of 10 kW; it generates laser radiation with a wavelength of approx. 1,070 nm. In two other embodiments (both not shown), the fiber laser has a laser output power of 16 kW and 20 kW respectively. The laser radiation emitted from the laser processing head is directed at the work surface, i.e. at the workpiece to be processed during operation.

The movement unit 106 comprises a transverse gantry 107 via which the laser processing head can be moved in the x and y directions relative to the support surface 103a, 103b. The transverse gantry comprises a support beam 108, which extends above the work table 102 and is supported at the side of the work table 102. The transverse gantry 107 with the support beam 108 can be moved on tracks 109a, 109b.

The laser protective hood 110 surrounds the laser processing head; it is only open towards the support surface 103a, 103b. It is double-walled and therefore has an outer wall and an inner wall. The wall thickness of the inner wall and the outer wall is 2 mm each. Between the outer wall and the inner wall exists a cavity in which two laser light sensors are arranged.

The laser protective housing 115 serves to protect against diffuse scattered light, such as that which could escape through the free space between the lower edge of the laser protective hood and the support surface/workpiece. The laser protective housing 115 consists of single-walled sheet metal elements 116 with a wall thickness of 2 mm. It has a length of 15,800 mm, a width of 8,000 mm and a height of 3,000 mm. For better visualization, only the side walls of the laser protective housing 115 are shown in FIG. 1. In fact, the ceiling of the laser protective housing 115 is also closed with sheet metal elements. The laser protective housing 115 is only open on the floor side. For this reason, the laser protective housing 115 is optically sealed from the floor 117. Furthermore, the laser protective housing 115 completely surrounds the laser processing unit, the movement unit 106 and the laser protective hood 110, but only partially surrounds the work table 102.

The laser protective housing 115 is movable on support rails 118a, 118b between a first position and a second position, wherein in the first position the first support surface 103a and in the second position the second support surface 103b is arranged within the laser protective hood 110. A workpiece on a support surface arranged inside the laser protective housing 115 can be processed with the laser processing unit. The support surface arranged outside the laser protective housing 115 can simply be loaded with a workpiece to be processed and the workpiece can be removed again after processing. The travel path of the movement unit 106 within the laser protective housing 115 is limited; it is selected such that a distance of 1,500 mm remains between the laser protective hood 110 and the laser protective housing 115 in the x and y directions and a distance of at least 90 mm remains between the laser protective hood 110 and the support surface 103 in the z direction.

FIGS. 2, 3 and 4 show a laser protective hood according to the invention in side view, in plan view and in an unfolded view. The laser protective hood is assigned the reference numeral 210. The laser protective hood 210 is configured for a laser processing head of a laser processing machine with a high laser output power. The laser processing head is not a component of the laser protective hood 210. For the sake of clarity, a laser processing unit with a laser processing head (X) is nevertheless shown hatched in FIG. 2. The laser protective hood 210 can be used instead of the laser protective hood 110 in the device shown in FIG. 1.

The laser protective hood 210 has double walls with an inner wall (not shown in FIGS. 2, 3 and 4) and an outer wall 220. The outer wall 220 and the inner wall of the laser protective hood 210 are each made of aluminum sheet with a sheet thickness of 2 mm. The outer dimensions of the laser protective hood (L×W×H) are (900 mm×930 mm×1,600 mm). The laser protective hood 210 covers an area of 0.76 m² on a support surface assigned to it (not shown here). There is a cavity between the inner wall and the outer wall 220 (not shown in FIGS. 2, 3 and 4). The width of the cavity, i.e. the distance from the inner wall to the outer wall 220, is 50 mm. The cavity comprises three subspaces 240a, 240b, 240c, the boundary of which is shown schematically in FIG. 4 as a dashed line. One of the three laser light sensors 221a, 221b, 221c projects into each subspace 240a, 240b, 240c. One laser light sensor 221a is arranged in the upper hood area 229. Due to the fact that the upper hood area 229 has a truncated pyramid shape and the laser light sensor 221a is arranged in the center, the entire upper hood area 229 can be monitored with one sensor. In an alternative embodiment, the upper hood area 229 is dome-shaped or conical. The rear side of the laser protective hood 210 is configured as a solid aluminum plate, on which a linkage 222 is arranged, via which the laser protective hood 210 can be attached to a movement unit and which simultaneously enables the laser protective hood 210 to be folded/tilted relative to the movement unit 106 into a mounting position. For this purpose, two handles 223 are provided, with which the laser protective hood can be lifted or pivoted upwards. This ensures accessibility to the laser processing head X, for example for manually changing the cutting nozzles.

FIG. 5 schematically shows the laser protective hood 210 according to the invention from FIGS. 2, 3 and 4 in section A-A′. The laser protective hood 210 has an outer wall 220 made of aluminum sheet with a sheet thickness of 2 mm and an inner wall 230 made of aluminum sheet with a sheet thickness of 2 mm. A cavity with a cavity width d of 50 mm is located between the outer wall 220 and the inner wall 230. The sides of the outer wall 220 and the inner wall 230 facing the cavity 240 are painted a light color (RAL7035 light grey) so that they reflect incident radiation. The two sensors 221b, 221c protrude into the cavity 240. Both sensors comprise a sensor element 221b-I, 221c-I arranged in the cavity 240 and an evaluation element 221b-II, 221c-II arranged outside the cavity 240, which contains electronic components for processing and forwarding a sensor signal provided by the sensor element 221b-I, 221c-I.

If the inner wall 230 is damaged during a processing operation and laser radiation 260 escapes through an opening 250 in the inner wall 230 into the cavity 240, the laser radiation 260 is deflected on the inside of the outer wall 230 or on the inside of the inner wall 230 in such a way that it strikes at least one of the sensor elements 221b-I, 221c-I. Damage is detected by the associated evaluation element 221b-II, 221c-II on the basis of the change in the associated sensor signal and the laser processing unit with the laser processing head X is switched off.

FIG. 6 shows in Figures A, B and C three laser protective hoods according to the invention, which differ in their outer hood geometry. Figure A shows a side view of a laser protective hood in which the upper hood region 729 is hemispherical in shape, with a laser light sensor 721 arranged in the upper hood region. Figure B shows a side view of a laser protective hood, with a dome-shaped upper hood region 729, in which two laser light sensors 721 are arranged in the upper hood region 729 and two laser light sensors 721 are arranged in the remaining hood region. Figure C shows a side view of a laser protective hood with an upper hood region 729, two laser light sensors 721 are arranged, and which tapers conically upwards.

FIG. 7 shows a laser protective hood 710 according to the invention with a laser processing head X arranged therein. The laser processing head X has a central longitudinal axis 745 (working axis); it can be pivoted in such a way that the central longitudinal axis 745 forms a pivot angle α of up to 50° with a surface normal 746 of the support surface 703. FIG. 7 also shows a laser beam 747 reflected by an ideally flat workpiece 701.

The laser protective hood 710 has a lower edge 751 that is spaced apart from the support surface 703. A free space 752 with a width of 130 mm remains between the lower edge 751 and the support surface 703. A laser protective curtain 753 is attached to the laser protective hood 710, which consists of flexible cladding parts that protrude into the free space 752. The laser protective curtain 753 is connected to the machine controller (not shown). Damage to one of the cladding parts of the laser protective curtain 753 causes the laser processing unit (not shown) to be switched off.

FIG. 8 shows a side view of a laser processing machine 600 with a work table 102, a laser processing unit (not shown in FIG. 6), a movement unit 601 and a laser protective hood 210.

The laser processing machine 600 is mounted on a stable and level floor 117. The floor 117 is provided with tracks 109, on which the movement unit 601 is supported via support elements 602 to the side of the work table 102 and on which the movement unit 601 can be moved. On the work table 102 there is a support surface for a workpiece (not shown in FIG. 6). A support beam 108 extends above the work table and thus transversely to the support surface, on which a movement element 125, with which the laser processing head and the laser protective hood 210 can be moved along the support beam 108 transversely to the work surface, is mounted. In addition, the movement element 125 enables movement of the laser processing head and the laser protective hood 210 in a direction perpendicular to the working surface.

The laser protective hood 210 corresponds to the laser protective hood described in FIGS. 2 to 5. It comprises an outer wall 220, an inner wall and a cavity between the outer wall and the inner wall, in which three laser light sensors 221a, 221b are arranged. The laser protective hood 210 is attached to the movement unit 601 in such a way that the laser protective hood 210 can be folded into a mounting position relative to the movement unit 601.

1-13. (canceled)

14. A device for the thermal processing of a workpiece with laser radiation, the device comprising:
a) a laser processing machine, having:
a support surface for supporting the workpiece;
a laser processing unit with a laser processing head;
a movement unit with a transverse gantry for moving said laser processing head relative to said support surface, said transverse gantry including a support beam that extends above said support surface, is supported laterally on said support surface, and is movable on tracks;
b) a laser protective hood surrounding said laser processing head, said laser protective hood being open towards said support surface and being disposed for movement by said movement unit together with said laser processing head, and said laser protective hood having an outer wall, an inner wall, and a cavity formed between said outer and inner walls and having at least one laser light sensor arranged in said cavity; and
c) a laser protective housing encasing said support surface, said laser processing unit, said movement unit, and said laser protective hood in form of a hood.

15. The device according to claim 14, wherein said laser processing unit (104) comprises a fiber laser configured to generate laser radiation with a wavelength in a range from 1,020 nm to 1,120 nm.

16. The device according to claim 14, wherein said support surface of said laser processing machine is a first support surface for a first workpiece and a second support surface for a second workpiece, and wherein said laser protective housing is movably disposed for selectively enclosing either said first support surface or said second support surface.

17. The device according to claim 14, wherein said laser protective hood comprises an upper hood region which is dome-shaped, conical or truncated pyramid-shaped, and wherein said at least one laser light sensor is one of at least two laser light sensors arranged in an upper hood region.

18. The device according to claim 14, wherein said laser processing head has a working axis and is pivotably supported relative to said laser protective hood such that the working axis forms a pivot angle α of up to 50° with a surface normal of said support surface, wherein said laser protective hood is dimensioned such that a laser beam reflected by an ideally flat workpiece strikes said inner wall of said laser protective hood independently of the pivot angle α.

19. The device according to claim 14, wherein said at least one laser light sensor arranged in said cavity is a number of laser light sensors selected from the group consisting of at least two laser light sensors, at least three laser light sensors, and at least four laser light sensors arranged in said cavity.

20. The device according to claim 14, wherein said cavity between said outer wall and said inner wall has a cavity width d in a range from 35 mm to 50 mm.

21. The device according to claim 14, wherein said laser protective hood covers an area in a range from 0.5 m² to 1.0 m² on said support surface.

22. The device according to claim 14, wherein said laser protective hood has a lower edge which extends at a distance from said support surface and leaves a free space therewith, and wherein a laser protective curtain is fitted with flexible cladding parts which project into the free space between said laser protective hood and said support surface and which are configured such that damage to one of said cladding parts by a laser beam causes said laser processing unit to be switched off.

23. The device according to claim 14, wherein said movement unit has a horizontal travel path which is limited to leave a minimum distance of 1.440 mm between said laser protective hood and said laser protective housing, and wherein said movement unit has a vertical travel path which is configured to leave a minimum distance of 90 mm between said laser protective hood and said support surface.

24. The device according to claim 23, wherein the vertical travel path of said movement unit is configured to leave a minimum distance of 100 mm between said laser protective hood and said support surface.

25. The device according to claim 14, wherein the laser radiation is generated by a fiber laser with a laser output power of at least 10 kW.

26. The device according to claim 25, wherein said fiber laser has a laser output power of at least at least 15 kW.

27. The device according to claim 25, wherein said fiber laser has a laser output power of at least at least 20 kW.

28. A laser protective hood for a laser processing head of a laser processing machine having a fiber laser which generates laser radiation, the laser protective hood comprising: an outer wall and an inner wall forming a cavity between said outer and inner walls, and at least one laser light sensor arranged in said cavity.

29. The laser protective hood according to claim 28 configured for a laser processing machine having a fiber laser configured to generate laser radiation with a wavelength in a range from 1,020 nm to 1,120 nm.

30. The laser protective hood according to claim 28, formed with an upper hood region which is dome-shaped, conical, or truncated pyramid-shaped, and wherein said at least one laser light sensor is one of at least two laser light sensors arranged in said upper hood region.

31. The laser protective hood according to claim 28, wherein said at least one laser light sensor is one of at least two laser light sensors arranged in said cavity.

32. The laser protective hood according to claim 31, wherein said at least one laser light sensor is one of at least three laser light sensors arranged in said cavity.

33. The laser protective hood according to claim 31, wherein said at least one laser light sensor is one of at least four laser light sensors arranged in said cavity.
